(19) United States
(12) Patent Application Publication
(10) Pub. No.: US 2006/0075470 A1
(43) Pub. Date: Apr. 6, 2006

(54) Storage network system and access control method

(76) Inventors: Toru Tanaka, Kawasaki (JP); Naoko Iwami, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/998,939

(22) Filed: Nov. 30, 2004

(30) Foreign Application Priority Data
Oct. 6, 2004 (JP) 2004-293391

(51) Int. Cl. H04L 9/32

(52) U.S. Cl. 726/2

(57) ABSTRACT

There is provided means for preventing a wrong DD from being registered to an initiator for storage devices connected to an IP network through iSCSI, thereby providing security functionality. A storage network system including hosts 100, an iSNS server 130, and storage devices 120 interconnected through a network and being capable of controlling access from an initiator to a target storage device 120, includes registration restriction setting means for making for each target a setting for allowing or preventing registration of an initiator. The iSNS server 130 has the registration restriction setting means.

The present application is based on and claims priority of Japanese patent application No. 2004-293391 filed on Oct. 6, 2004, the entire contents of which are hereby incorporated by reference.

### BACKGROUND OF THE INVENTION

1. Field of the Invention

The present invention relates generally to a technology for enhancing the security of storage devices connected to a network, and in particular, to a technology for enhancing the security of storage devices connected to a network via ISCSI (Internet Small Computer Systems Interface).

2. Description of the Related Art

IP (Internet Protocol) networks are commonly used to interconnect computers. As described in IETF (Internet Engineering Task Force) RFC 3720, iSCSI (Internet Small Computer Systems Interface) can be used to connect storage devices such as RAIDs (Redundant Array of Independent Disks) to an IP (Internet Protocol) network and to operate the same through SCSI (Small Computer System Interface) commands encapsulated into IP packets.

Like SCSI, iSCSI provides a client/server model consisting of initiators, which send SCSI commands to request processing such as input and output processing, and targets, which respond to the input and output requests.

The iSCSI is defined as an iSCSI layer in the network hierarchy, which is positioned between the SCSI layer and the TCP/IP layer. The iSCSI layer receives a SCSI CDB (Command Describe Block), response, or data from the iSCSI layer and encapsulates the same into an iSCSI PDU (Protocol Data Unit) and sends it through a TCP connection. An iSCSI layer receives an iSCSI PDU through the TCP connection, processes it to extract an SCSI CDB, response, or data, and provides it to the SCSI layer.

The iSCSI uses SCSI Command PDUs to send SCSI CDBs, uses SCSI Data Input/Output PDUs to transfer data, and uses SCSI Response PDUs to send SCSI responses.

The iSCSI nodes such as initiators and targets have iSCSI names for identifying and managing them. An iSCSI name must be independent of geographical information about the iSCSI node, must be unique worldwide, and must be fixed in the period from activation to termination of the iSCSI node. Formats that can be used for iSCSI names include iSCSI Qualified Name and Extended Unique Identifier.

In iSCSI, an IP address, TCP port number, and iSCSI name are necessary for an initiator to establish an iSCSI session with a target. An initiat or can find these items of information according to one of the following three ways.

A first method is direct setting in which an IP address, TCPport number, and iSCSI name are directly set in the initiator. The initiator uses the IP address of the target to establish a TCP connection and uses the iSCSI name of the target to establish an iSCSI connection.

A second method is Send Targets. This sets the IP address and TCP port number of the target in the initiator. The initiator uses this information to establish a discovery session with a network entity. This setting method is used for iSCSI gateways and iSCSI routers.

A third method is zero configuration in which no information about the target is set in the initiator. The initiator sends a multicast directly to the targets or sends a discovery message to a storage name server. There are two methods for implementing target-discovery functionality, a method specified in RFC 2608 which uses SLP (Service Location Protocol) and a method disclosed to the public in a draft “draft-ietf-ips-isns-22.txt” as of February 2004 which uses iSNS (Internet Storage Name Service). In general, iSNS should be used in a large-scaled storage network.

As described in the draft “draft-ietf-ips-isns-22.txt,” iSNS is a technology that enables resolution of initiator and target names and group management using DD (Discovery Domain) in an iSCSI-based IP-SAN.

An initiator uses a DevAttrReg message of iSNS to register information about a target to an iSNS server during boot up. A DevAttrReg message consists of a Source Attribute indicating the source ISCSI node, a Message Key Attribute used for determining whether the target is an existing iSCSI node, a Delimiter Attribute, which is a delimiter, and an Operating Attribute, which describes additional information.

If the initiator sends a DevAttrReg message without a DD designation to the iSNS server during boot up, the initiator can belong to a default DD or no DD. Thus, the initiator can discover a target within the DD to which the initiator belongs.

Non-patent document 1: J. Satran, K. Meth, C. Sapuntzakis, M. Chadalapaka, E. Zeidner, “Internet Small Computer Systems Interface (iSCSI),” RFC3720, April 2004;

Non-patent document 2: M. Bakke, J. Hafner, J. Hufferd, K. Voruganti, M. Krueger, “Internet Small Computer Systems Interface (iSCSI) Naming and Discovery,” RFC3721, April 2004;

Non-patent document 3: Josh Tseng, Kevin Gibbons, Franco Travostino, Curt Du Laney, Joe Souza, “Internet Storage Name Service (iSNS),” draft-ietf-ips-isns-22.txt, February 2004.

If an iSCSI-based IP-SAN is built with storage devices connected to an IP network, the storage devices can be accessed by hosts which connect to various IP networks, which poses security breach problems such as unauthorized access. In order to prevent such problems, a technology known as access control is necessary which defines access from hosts to storage devices that should be permitted and access that should be denied.

An access control technology commonly used on IP networks is IP filtering which is provided on a firewall for permitting or preventing access by pairs of source and target IP addresses and ports. This technology prevents services from being unnecessarily disclosed to IP networks. Another solution commonly used is VLAN (Virtual LAN) technology which forms virtual groups of network devices such as switches independently of physical connection locations.

To implement access control on ISCSI, DDs of the ISNS must be used. Using a DD allows an initiator to discover targets only within the DD to which the initiator belongs. However, an administrator of the host accessing storage devices can specify an ID identifying a DD as an operating attribute when registering an initiator to an iSNS server by using a DevAtrrReg message. Therefore, various problems may occur if a wrong DD is specified.

First, the initiator can discover targets that are not intended by the administrator and can make unauthorized access to a volume.

Second, the initiator cannot discover an intended target to which it wants to access.

Third, management to avoid these problems will be complicated.

There is provided means for preventing a wrong DD from being registered to an initiator for storage devices connected to an IP network through ISCSI, thereby providing security functionality.

### SUMMARY OF THE INVENTION

In order to solve the problem, the present invention provides in an iSNS server resolving the names of iSCSI initiators and targets on an IP network, means for determining based on a given setting whether or not DD registration should be allowed and for registering an initiator and a target to a specified DD, as well as a network interface which handles IP and iSCSI protocol, and an iSNS processing program which performs processes such as resolution of initiator and target names and DD registration.

In a database of the iSNS server, a field for restricting registration is added to the record of each DD. An administrator uses a control node to set a value in this field. Determination is made based on information entered in the field as to whether an iSCSI node is allowed to register with the DD.

Thus, the initiator cannot register with a DD that is not intended by the administrator in an environment in which it can readily discover a target by using iSNS, and therefore, unauthorized access to the storage devices can be prevented. Accordingly, the security level of the IP-SAN can be improved.

According to the present invention, there is provided in an iSNS server, means for determining based on a given setting whether DD registration is allowed and for registering an initiator and a target to a specified DD, as well as a network interface for handling IP and iSCSI protocol, and an iSNS processing program which performs processes such as initiator and target name resolution and DD registration. Determination is made as to whether an iSCSI node is allowed to register with the DD, based on information set in a field added to the record of each DD for restricting registration. Thus, the present invention has the advantage that anode cannot be registered to a DD that is not intended by the administrator and unauthorized access to storage devices can be prevented, thereby improving the security level of the IP-SAN.

Furthermore, because DD registration is made based on information desired and preset by the administrator, the need for DD registration setting for each node is eliminated and thus maintenance costs can be reduced.

### BRIEF DESCRIPTION OF THE DRAWINGS

FIG. 1 is a diagram illustrating a system configuration according to a first embodiment;

FIG. 2 is a diagram illustrating a configuration of a memory on a host according to the first embodiment;

FIG. 3 is a diagram illustrating a configuration of a storage device according to the first embodiment;

FIG. 4 is a diagram illustrating a configuration of an iSNS server according to the first embodiment;

FIG. 5 is a diagram illustrating a configuration of a storage on the iSNS server according to the first embodiment;

FIG. 6 is a diagram illustrating a configuration of a memory on the iSNS server according to the first embodiment;

FIG. 7 is a diagram illustrating a configuration of an iSNS database according to the first embodiment;

FIG. 8 is a diagram illustrating an exemplary structure of a storage node information table according to the first embodiment;

FIG. 9 is a diagram illustrating an exemplary structure of a discovery domain information table according to the first embodiment;

FIG. 10 is a diagram illustrating an exemplary message flow according to the first embodiment;

FIG. 11 is a flowchart illustrating an iSNS processing program on a host according to the first embodiment;

FIG. 12 is a flowchart illustrating initialization of the iSNS processing program on the host according to the first embodiment;

FIG. 13 is a flowchart illustrating an ISNS processing program on iSNS server according to the first embodiment;

FIG. 14 is a flowchart illustrating initialization of the iSNS processing program on the iSNS server according to the first embodiment;

FIG. 15is a flowchart illustrating a DD managing program on the iSNS server according to the first embodiment;

FIG. 16 is a flowchart illustrating initialization of the DD managing program on the ISNS server according to the first embodiment;

FIG. 17 is a diagram illustrating a configuration of an iSNS database according to a second embodiment;

FIG. 18 is a diagram illustrating a configuration of a discovery domain information table according to the second embodiment;

FIG. 19 is a diagram illustrating a configuration of an ACL information table according to the second embodiment;

FIG. 20 is a flowchart illustrating a DD managing program on an iSNS server according to the second embodiment;

FIG. 21 is a diagram illustrating a system configuration according to a third embodiment;

FIG. 22 is a diagram illustrating a configuration of a management terminal according to the third embodiment;

FIG. 23 is a diagram illustrating a configuration of a memory on the management terminal according to the third embodiment;

FIG. 24 is a diagram illustrating a configuration of a storage in the management terminal according to the third embodiment;

FIG. 25 is a diagram illustrating a configuration of DD management database according to the third embodiment;

FIG. 26 is a diagram illustrating an exemplary message flow according to the third embodiment;

FIG. 27 is a diagram illustrating an exemplary discovery domain information edit screen according to the first embodiment;

FIG. 28 is a diagram illustrating an exemplary ACL information edit screen according to the second embodiment; and

FIG. 29 is a flowchart illustrating a data managing program according to the first embodiment.

### DETAILED DESCRIPTION OF THE PREFERRED EMBODIMENTS

The best mode for implementing the present invention will be described below.

Embodiments of a storage network and access control method of the present invention will be described below in detail with reference to the accompanying drawings.

### First Embodiment

The following is the description of a first embodiment. FIG. 1 shows a system configuration of a storage network system according to the first embodiment. In FIG. 1, a host 100, which is a node that performs input/output operations to storage devices 120, includes a network interface 101 for sending and receiving data to and from a network, a CPU 102 executing programs to control the entire host, a memory 103 providing a memory area for programs, a storage 104 for storing programs and user data, etc., an input device 105 such as a keyboard and a mouse for inputting information by a user, an output device 106 such as a display for presenting outputs to the user, and a bus 107 for transferring these data. The switch 110 is a network device for relaying interactions between one or more hosts 100, one or more storage devices 120, and an iSNS server 130. More than one switch 110 may be provided. The storage devices 120 are nodes accepting inputs and outputs from the host 100. The iSNS server 130, which is a node responding to iSNS requests from the host 100 and storage devices 120 by performing processes, can make a setting allowing or preventing registration of initiators and also can make a setting for placing no restrain on registration of initiators.

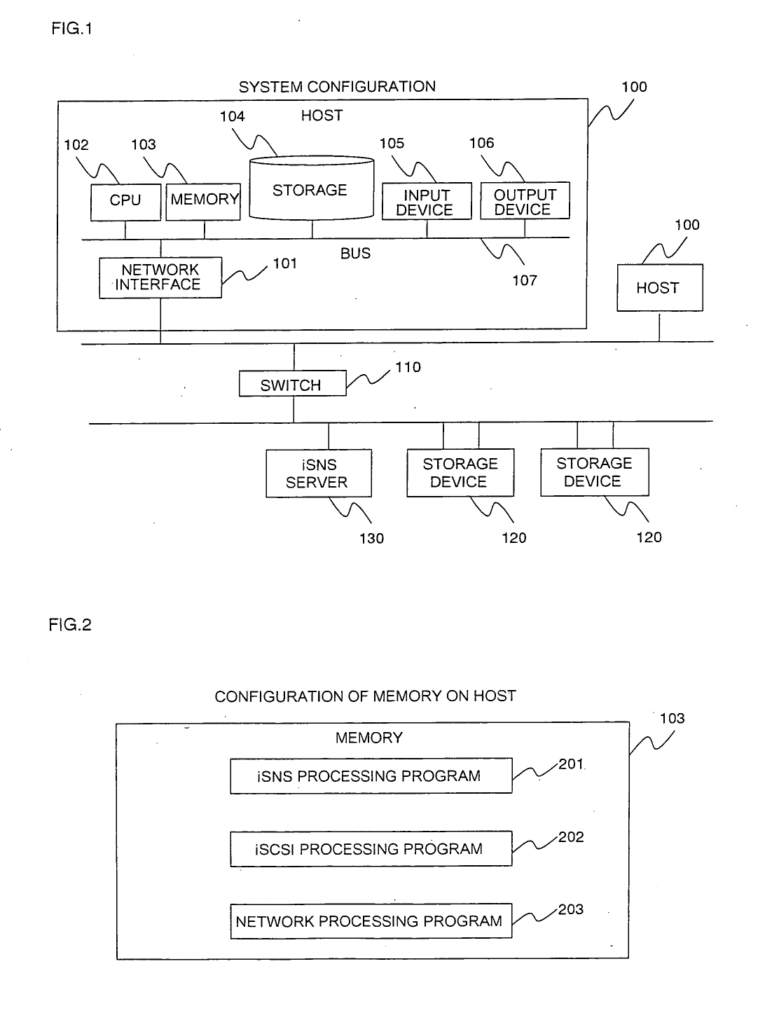

FIG. 2 shows a configuration of the memory of the host. The memory 103 contains a network processing program 203 for sending and receiving data to and from the network interface 101, an iSCSI processing program 202 for processing iSCST PDUs received from the network processing program 203, and an iSNS processing program 201 responsible for processing iSNS messages.

FIG. 3 shows a configuration of a storage device. The storage device 120, which is a node accepting inputs/outputs from the host 100, includes a network interface 301 for sending and receiving data to and from the network, a CPU 302 executing programs to control the entire storage device 120, a memory 303 for storing programs, a plurality of storages 305 storing user data, a storage controller 304 for controlling the storages, a storage bus 307 for transferring storage data, a control bus 306 for transferring control information , and a management interface 308 for controlling the storage device.

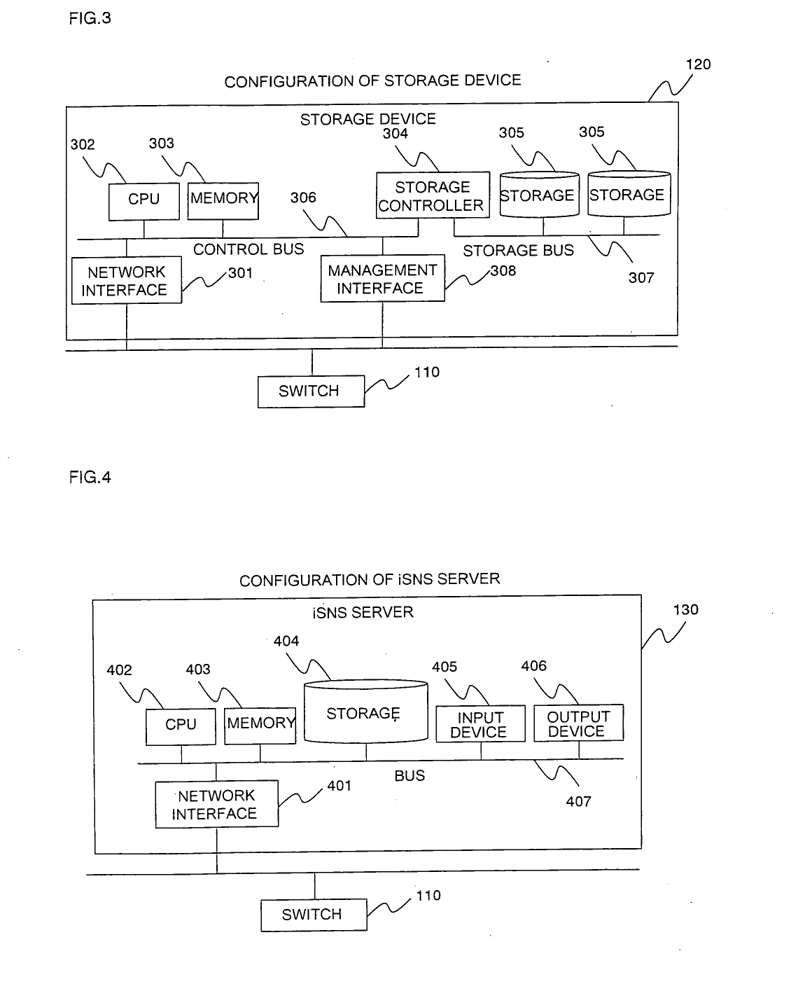

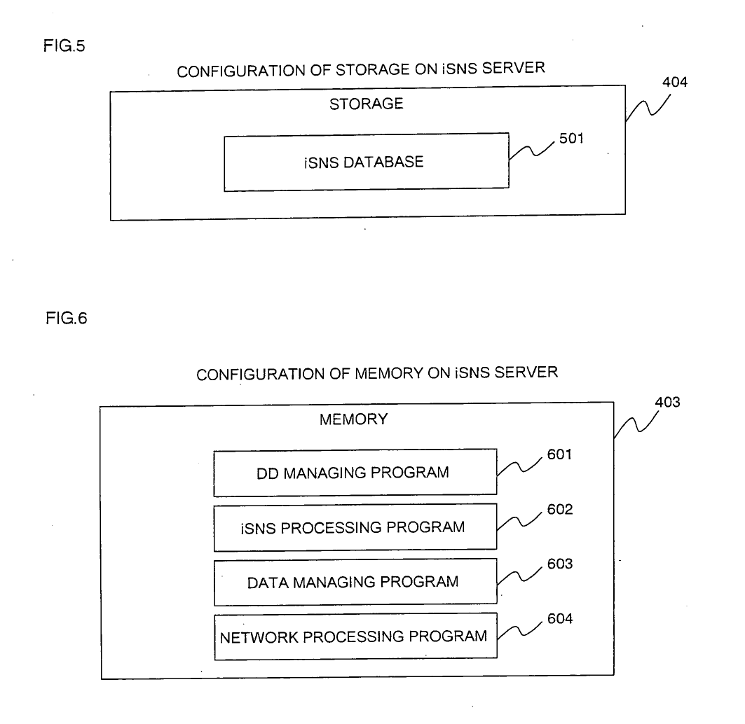

FIG. 4 shows a configuration of the iSNS server. The iSNS server 130, which is a node responding to iSNS request from the host 100 and storage devices 120 by performing processes, includes a network interface 401 for sending and receiving data to and from the network, a CPU 402 executing programs to control the entire iSNS server 130, a memory 403 providing a storage area for programs, a storage 404 for storing programs and user data, an input device 405 such as a keyboard and mouse for inputting information by a user, an output device 406 such as a display for presenting outputs to the user, and a bus 407 for transferring these data. The input device 405 and the output device 406 are not used in typical operation; the iSNS server 130 can operate without the input device 405 and the output device 406.

FIG. 5 shows a configuration of the storage of the iSNS server. The storage 404 contains an iSNS database 501 for an iSNS processing program 602 on the iSNS server 130 to read/write data.

FIG. 6 shows a configuration of the memory of the iSNS server. During boot up, the iSNS server 130 loads into the memory 403 a network processing program 604 for sending and receiving data to and from the network interface 401, a data managing program 603 for managing data in accordance with operations on a display screen, an ISNS processing program 602 for transferring iSNS to and from the hosts 100 and storage devices 120, and a DD managing program 601, which is a feature of the present invention. Also, the iSNS processing program 601 is a software for implementing specifications described in non-patent document 3. Functions of the DD managing program 601 may be included in the iSNS processing program.

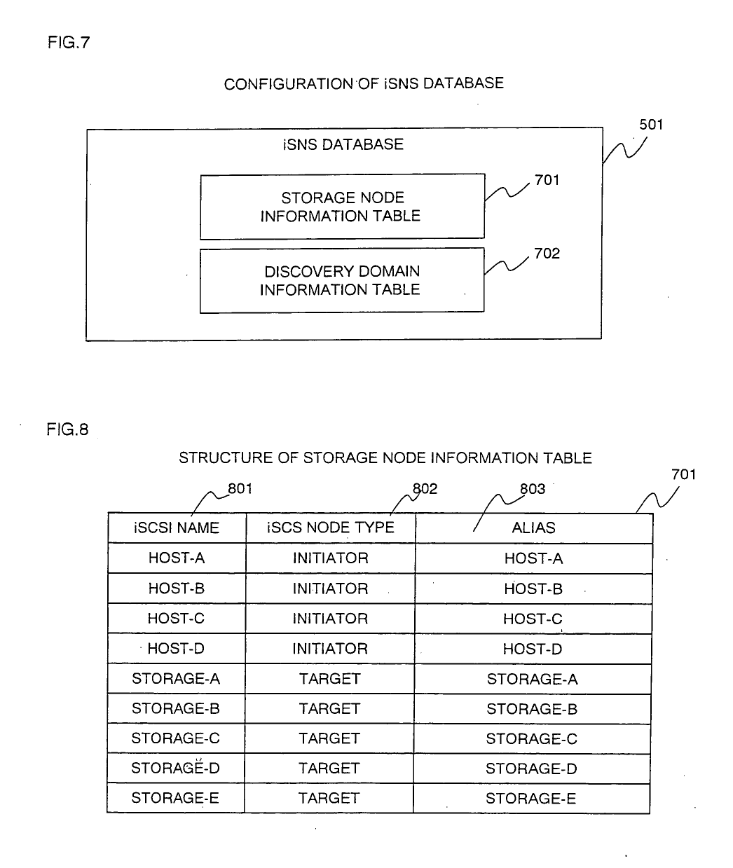

FIG. 7 shows a configuration of the iSNS database. The iSNS database 501 contains information about the initiators and targets existing in each portal and includes a storage node information table 701 and a discovery domain information table 702.

FIG. 8 shows an exemplary structure of the storage node information table. The storage node information table 701 contains iSCSI names 801 uniquely identifying nodes, iSCSI node types 802 indicating the types of the nodes, that is, whether initiator or target, and aliases 802, which are character strings representing the iSCSI names 801, which tend to be complicated and long, in a easy-to-remember human-readable format.

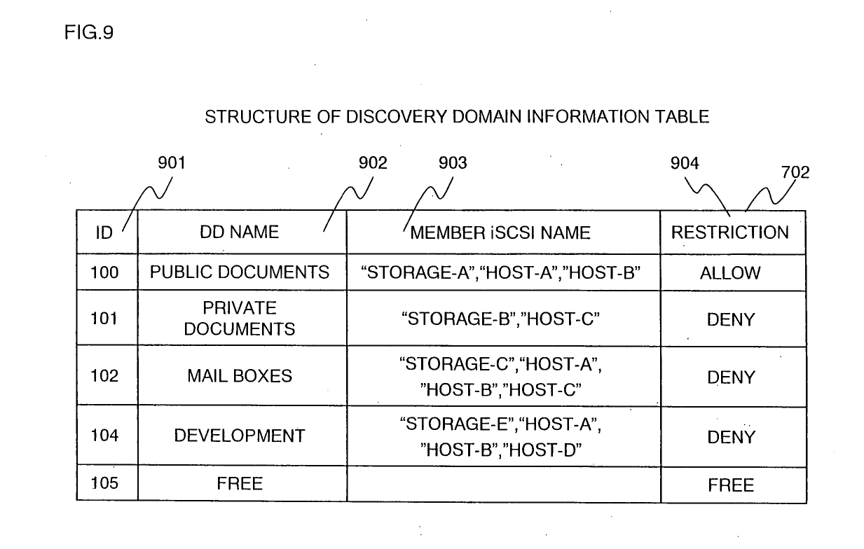

FIG. 9 shows an exemplary structure of the discovery domain information table. The discovery domain information table 702 contains IDs 901 uniquely identifying DDs, DD names 902 indicating the types of the DDs, member iSCSI names 903 describing the iSCSI names of the DD members, and restriction information 904, which is a feature of the present invention and restricts DD registration. The restriction 904 column contains the character string “Allow” indicating that hosts are allowed to register with the DD, the character string “Deny” indicating that hosts are not allowed to register with the DD, or the character string “Free” indicating that hosts are allowed to register with the DD if they were unable to register with other DDS. The character strings Allow, Deny, and Free indicate the types of restriction and different characters strings can be used by different systems.

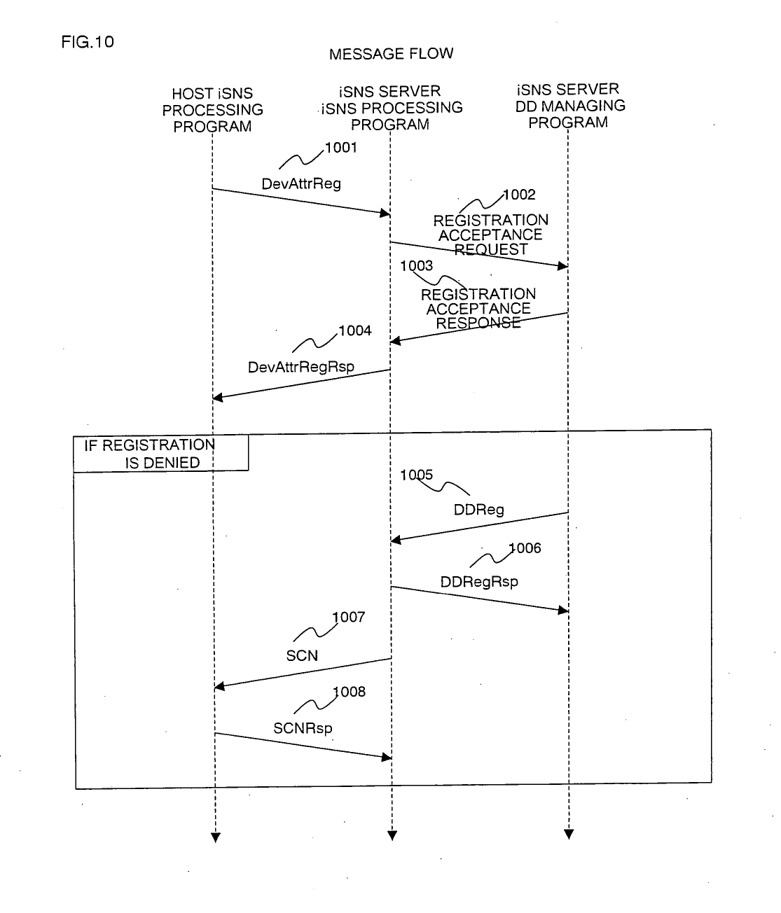

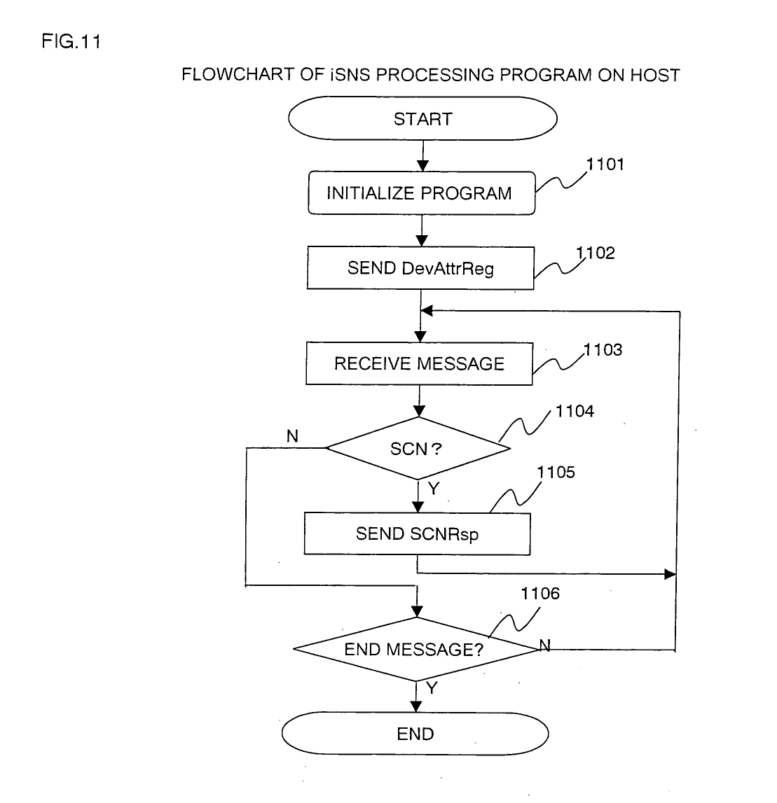

FIG. 10 shows an exemplary message flow. The iSNS processing program 201 on a host 100 sends a DevAttReg message 1001 to the iSNS processing program 602 on the iSNS server 130. The iSNS processing program 602 receives the message and sends a registration acceptance request message 1002 to the DD managing program 601 of the iSNS server 130. The DD managing program 601 of the iSNS server 130 receives the message, determines whether the host 100 is allowed to register with the DD, and sends a registration acceptance response message 1003 to the iSNS processing program 602 of the iSNS server 130. When receiving the message, the iSNS processing program 602 of the iSNS server 130 sends a DevAttrRegRsp message 1004 to the iSNS processing program 201 on the host 100. If the response to the registration acceptance request message 1002 is denial, then the DD managing program 601 of the iSNS server 130 sends a DDReg message 1005 to the iSNS processing program 602 of the iSNS server 130 in order to register the host 100 with another DD. When receiving the message, the iSNS processing program 602 of the iSNS server 130 registers the host 100 with the specified DD and sends a DDRegRsp message 1006 to the DD managing program 601 of the iSNS server 130. When the DD is changed, the iSNS processing program 602 on the iSNS server 130 sends an SCN message 1007 to the ISNS processing program 201 on the host 100. The iSNS processing program 201 of the host 100 receives the message and sends an SCNRsp message 1008 to the ISNS processing program 602 of the iSNS server 130.

FIG. 11 shows an illustrative flowchart of the ISNS processing program on the host. The ISNS processing program 201 performs program initialization (step 1101) and sends a DevAttrReg message including the ID 901 of a DD with which the host 100 wants to register (step 1102). Then, the iSNS processing program 201 receives a message (step 1103), and determines whether the message is SCN (step 1104). If it is SCN, the iSNS processing program 201 sends SCNRsp and returns to step 1103. Otherwise, the iSNS processing program 201 determines whether it is an end message (step 1106). If it is an end message, the process will end. Otherwise, the program returns to the message receiving step (step 1103).

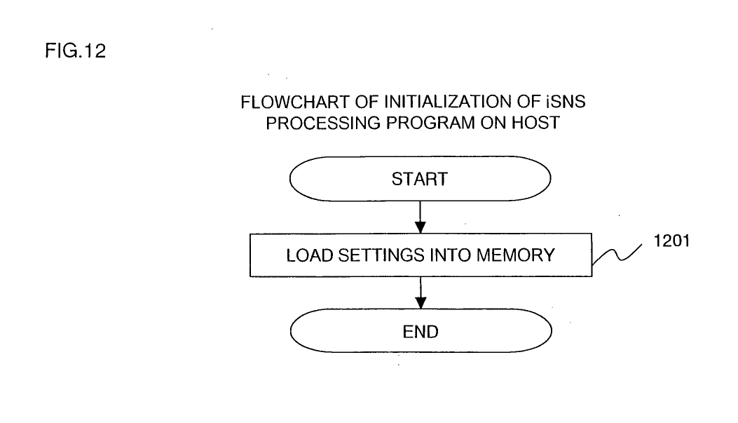

FIG. 12 shows an illustrative flowchart of initialization of the iSNS processing program on the host. The iSNS processing program 201 loads settings into the memory (step 1201), then the process will end.

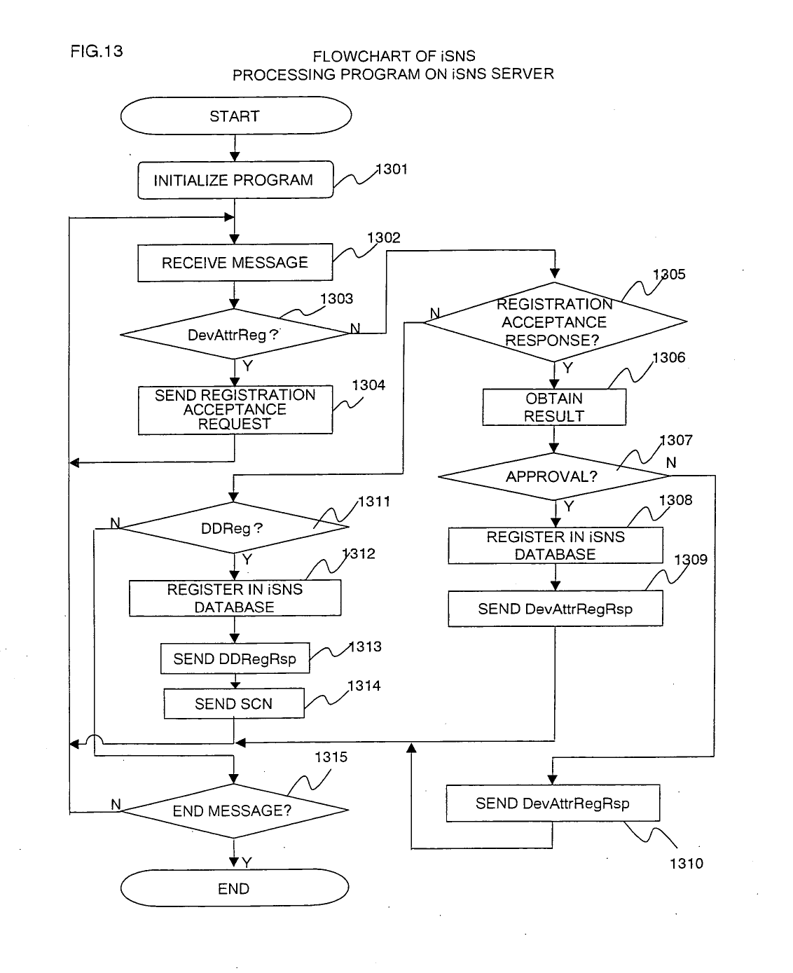

FIG. 13 shows an illustrative flowchart of the iSNS processing program on the iSNS server. The ISNS processing program 602 performs program initialization (step 1301), and receives a message (step 1302). If the message is DevAttrReg, the program sends a registration acceptance request message to the DD management program 601 (step 1304) and returns to message receiving step (step 1302). If it is determined at step 1303 that the message is not DevAttrReg, the program determines whether the message is a registration acceptance response (step 1305). If it is a registration acceptance response, the program obtains the result indicated in the response (step 1306) , determines whether the result indicates approval (step 1307). If it is approval, then the program registers the DD to the ISNS database (step 1308) and sends DevAttrRegRsp indicating that the request has succeeded to the iSNS processing program 201 of the host 100 (step 1309). If the result at step 1307 does not indicate approval, the program sends DevAttrRegRsp indicating that the request has failed (step 1310) and returns to step 1302. If the message received at step 1305 is not a registration acceptance response, the program determines whether it is DDReg (step 1311). If it is DDReg, then the program adds items of information to the storage node information table 701 and the discovery domain information table 702 in the iSNS database 501 in order to register the node with the specified DD (step 1312), sends DDRegRsp (step 1313), sends SCN indicating the change in status of the node (step 1314), and then returns to step 1302. If the message received at step 1311 is not DDReg, the program determines whether it is an end message (step 1315). If it is an end message, the program will end. If it is determined at step 1315 that the message is not an end message, the program returns to message receiving step (step 1302).

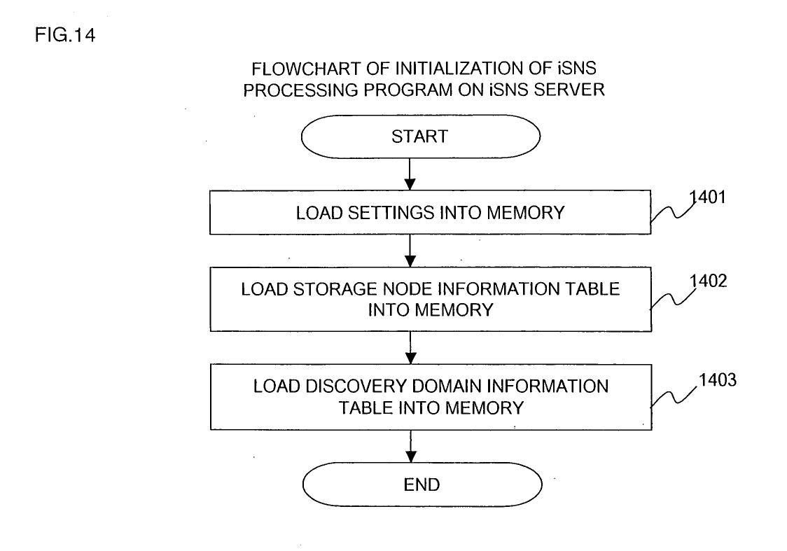

FIG. 14 shows an illustrative flowchart for initializing the iSNS processing program on the iSNS server. The iSNS processing program 602 loads settings into the memory (step 1401), loads the storage node information table into the memory (step 1402), loads discovery domain information table into the memory (step 1403), and ends the process.

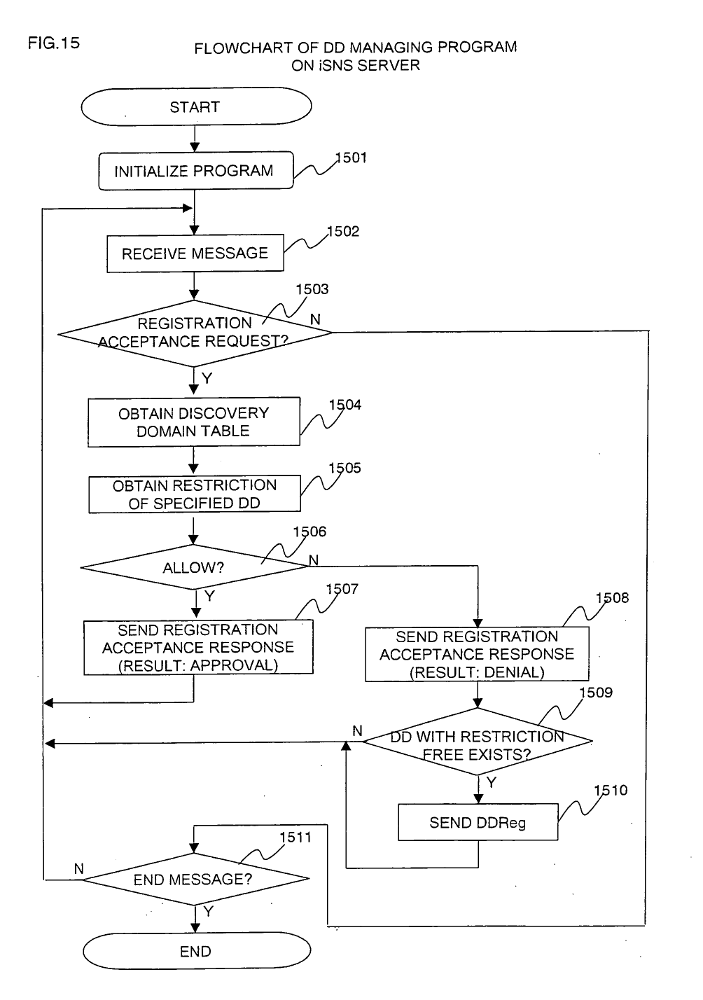

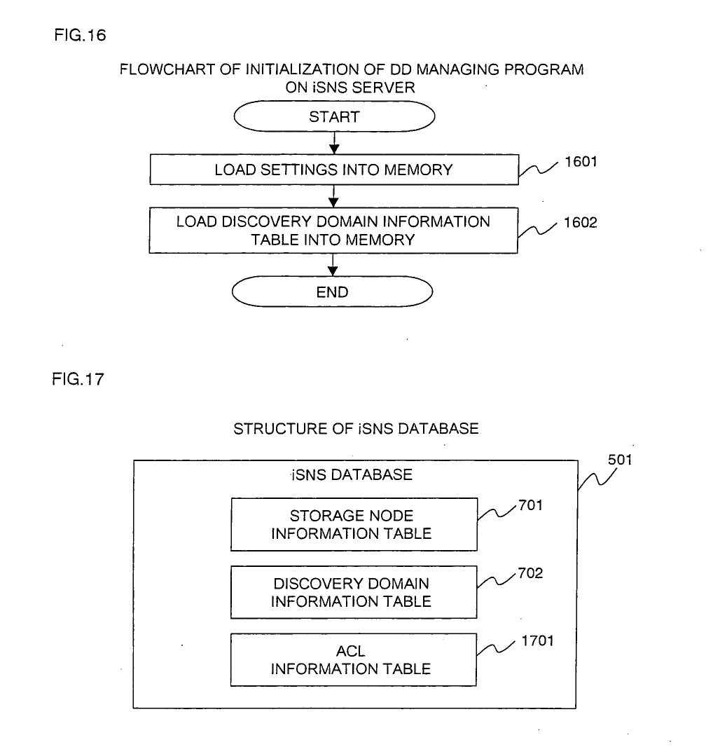

FIG. 15 shows an illustrative flowchart of the DD managing program on the ISNS server, which is a feature of the present embodiment. The DD managing program 601 performs program initialization (step 1501), receives a message (step 1502), and determines whether the message is a registration acceptance request (step 1503). If it is a registration acceptance request, the program obtains the discovery domain information table 702 (step 1504), obtains the restriction for the specified DD (step 1505), and determines whether the restriction is “Allow,” (step 1506). If it is “Allow,” the program sends a registration acceptance response that indicates approval to the iSNS processing program 602 (step 1507), and then returns to step 1502. If the determination at step 1506 is that the restriction is not “Allow,” the program sends a registration acceptance response that indicates denial to the ISNS processing program 602 (step 1508), and determines whether the discovery domain information table 702 contains a DD whose restriction is “Free” (step 1509). If such a DD exists, the program sends DDReg for registering the host 100 with that DD to the iSNS processing program 602 (step 1510), and returns to the message receiving step (step 1502). If the determination at step 1509 is that there is no DD whose restriction is “Free,” the program returns to the message receiving step (step 1502). If the message received at step 1503 is not a registration acceptance request, the program determines whether it is an end message (step 1511). If it is an end message, the program ends; otherwise the program returns to the message receiving step (step 1502).

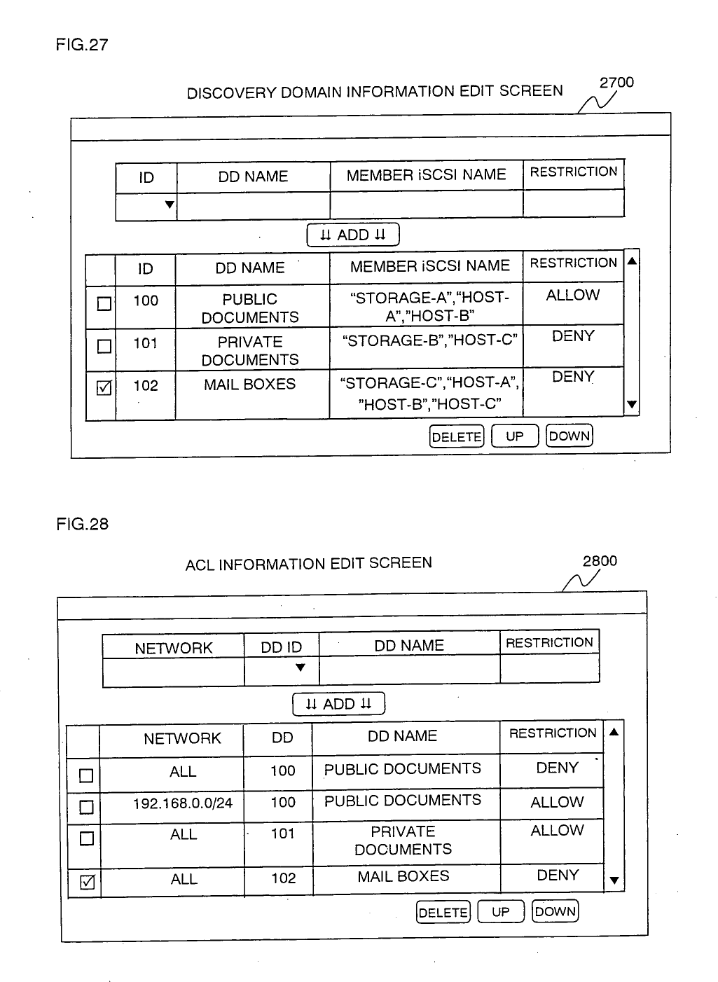

FIG. 27 shows an example of a discovery domain information edit screen. The discovery domain information edit screen 2700 is a screen for editing the discovery domain information table 702. By performing operations on this screen, the data managing program can be activated and information can be added to, edited, and deleted from discovery domain information table 702.

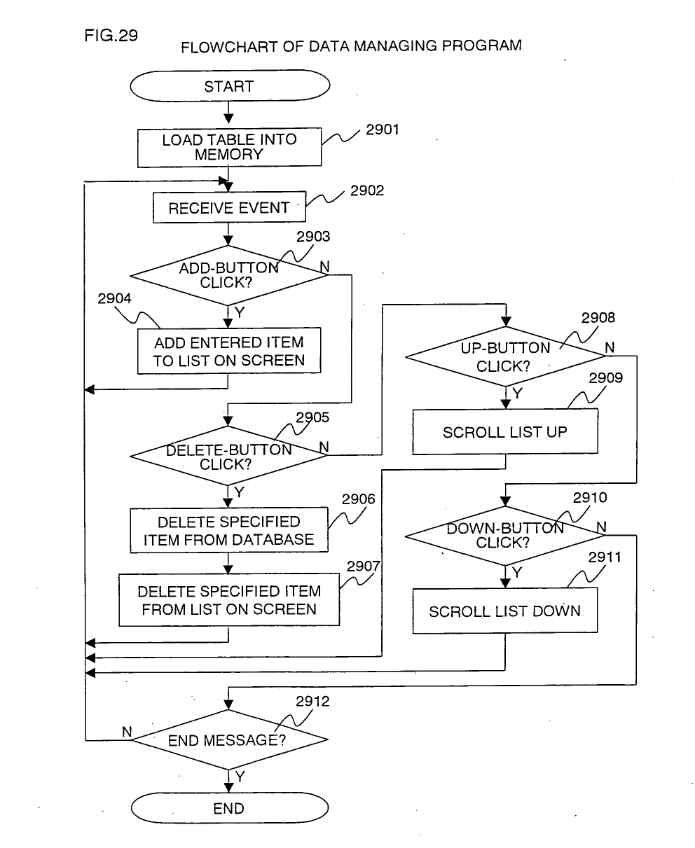

FIG. 29 shows an illustrative flowchart of the data managing program. The data managing program 602 loads the discovery domain information table 702 into the memory (step 2901), receives an event (step 2902), and determines whether the event is a click on the add-button (step 2903). If it is an add-button click, then the program adds an inputted item to the list on the screen (step 2904) and returns to step 2909 for receiving another event. If the determination step 2903 is that the event is not an add-button click, then the program determines whether the event is a click on the delete-button (step 2905). If it is a delete-button click, the program deletes a specified item from the discovery domain information table 702 (step 2906), deletes the item from the list on the screen (step 2907), and returns to the step 2902 for receiving another event. If the determination at step 2905 is that the event is not a delete-button click, the program determines whether it is an up-button click (step 2908). If it is an up-button click, the program scrolls the list up (step 2909) and returns to step 2902 for receiving another event. If the determination at step 2908 is that the event is not an up-button click, the program determines whether the event is a click on the down-button (step 2910). If it is a down-button click, the program scrolls the list down (step 2911) and returns to step 2902 for receiving another event. If the determination at step 2910 is that the event is not a down-button click, the program determines whether it is an end message (step 2912). If it is an end message, the program ends. If the determination at step 2912 is that the event is not an end message, program returns to step 2902 for receiving another event.

According to the present embodiment, if a host 100 attempts to register with a DD, the DD managing program, 601 determines based on a restriction 904, which has been entered in the discovery domain information table 702 through the discovery domain information edit screen 2700, whether the host 100 is allowed to register with the DD. If the restriction 904 is “Allow,” the program registers the host 100 with the specified DD. Otherwise, it registers the host 100 with a DD whose restriction is “Free.” Thus, registration of hosts to individual DDs can be restricted and registration to a DD that is not intended by an administrator can be prevented, consequently improving the level of security is improved.

### Second embodiment

A second embodiment will be described below. The system configuration of the second embodiment is the same as that in the first embodiment (see FIG. 1) and therefore detailed description of which will be omitted. The following description will focus on differences from the first embodiment. FIG. 17 shows a structure of an iSNS database. The iSNS database 501 includes a storage node information table 701 containing information such as initiators and targets at individual portals, a discovery domain information table 702 containing information about DDs (discovery domain) defining a domain in which an initiator or target can be discovered, and an ACL information table 1701 containing information about DD registration approval. Settings for inquiring about restrictions on registration of initiators are made and information about restrictions on registration to be returned in response to such queries is stored in the ISNS database 501. The structure of the storage node table 701 is the same as that of the first embodiment.

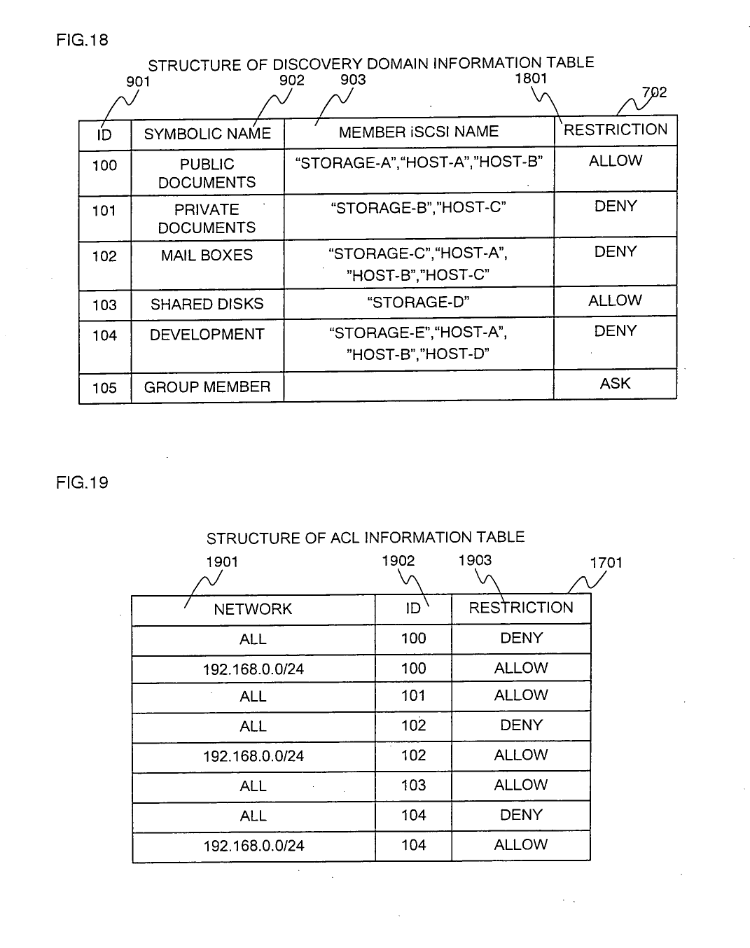

FIG. 18 shows an exemplary structure of the discovery domain information table 702. The discovery domain information table 702 contains IDs 901 uniquely identifying DDs, symbolic names (DD names) 902 indicating the types of the DDs, member iSCSI names 903 describing the iSCSI names of DD members, and restriction information 1801, which is a feature of the present embodiment, for restricting DD registration. The restriction information 1801 includes the character string “Allow”, which indicates that DD registration is allowed, the character string “Deny”, which indicates that DD registration is not allowed, and the character string “Ask,” which indicates that determination as to whether or not DD registration is allowed is made according to the ACL information table 1701.

FIG. 19 shows an exemplary structure of the ACL information table 1701. The ACL information table 1701 includes networks 1901, each of which is a unit of DD registration (a unit whose registration with a DD is allowed or denied), IDs 1902 uniquely identifying DDs for registration, and restrictions 1903 for restricting registration of the networks to the DDs. The restriction 1903 column contains the character string “Allow” indicating that DD registration is allowed and the character string “Deny” indicating that DD registration is not allowed. In the network 1901 column, domain names may be used instead of the network identifies shown.

The flow of messages is the same as in the first embodiment (see FIG. 10). The same flowcharts used in the first embodiment (see FIGS. 11 and 13) are used for illustrating an iSNS processing program 201 of a host 100 and an iSNS processing program of an iSNS server 130.

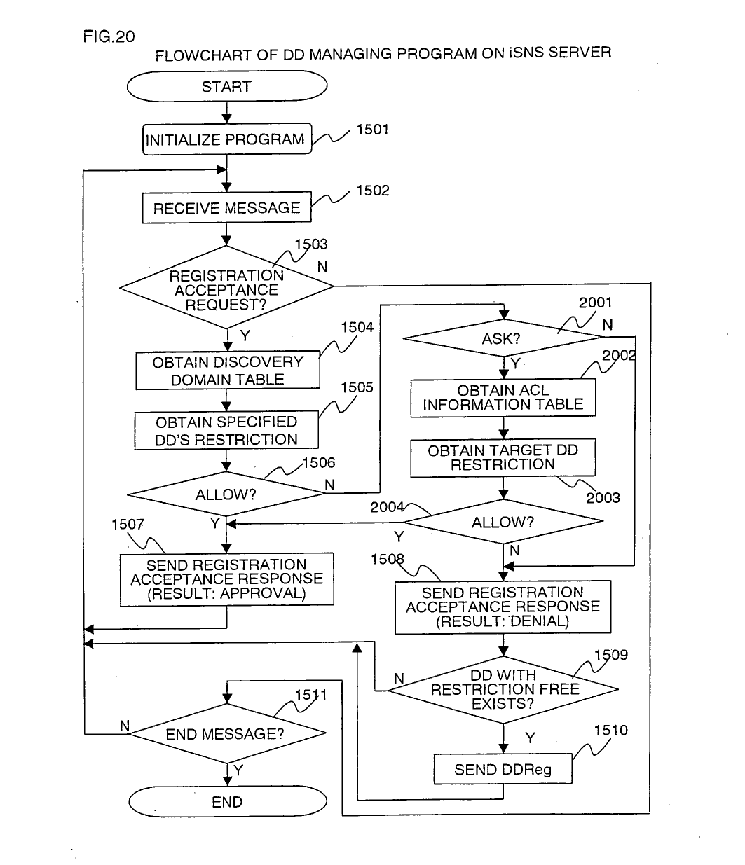

FIG. 20 shows an illustrative flowchart of a DD managing program 601 on an iSNS server. Steps 1501 to 1507, and step 1511 are the same those shown in FIG. 15 of the first embodiment, and therefore the description of which will be omitted. The program 601 operates differently from that in the first embodiment if it is determined at step 1506 that the restriction is not “Allow.” This case will be described below. At step 1506, if the restriction is not “Allow,” the program 601 determines whether it is “Ask” (step 2001). If it is “Ask,” then the program 601 obtains the ACL information table 1701 (step 2002), identifies the network to which a host 100 to be registered belongs, obtains the restriction specification for a specified DD (step 2003), and determines whether the restriction is “Allow” (step 2004). If it is “Allow,” the program 601 sends a registration acceptance response that indicates approval to the iSNS processing program 602 (step 1507). If the determination at step 2004 is that the restriction is not “Allow,” the program 601 sends a registration acceptance response that indicates denial to the iSNS processing program 602 (step 1508), and determines whether the discovery domain information table 702 contains a DD whose restriction is “Free” (step 1509). If a DD whose restriction is “Free” exists, then the program 601 sends DDReg for registering the host 100 with that DD to an iSNS processing program 602 (step 1510) and returns to the message receiving step (step 1502). If no DD whose restriction is “Free” exist, the program 601 returns to the message receiving step (step 1502). If the determination at step 2001 is that the restriction is not Ask, the program 601 sends a registration acceptance response that indicates denial to the iSNS processing program 602 (step 1508) and proceeds to step 1509, which has been described earlier. If a message received at step 1503 is not a registration acceptance request, the program 601 determines whether it is an end message (step 1511). If it is an end message, the program 601 ends; otherwise the program 601 returns to the message receiving step (step 1502).

FIG. 28 shows an example of an ACL information edit screen. The ACL information edit screen 2800 is used for editing the ACL information table 1701. By performing operations on this screen, a data managing program can be activated and information can be added to, edited, and deleted from the ACL information table 1701. The flowchart of the data managing program is the same as that in the first embodiment.

According to the present invention, if a host 100 attempts to register with a DD, the DD managing program 601 determines based on the restriction 1801, which has been entered in the discovery domain information table 702 through a discovery domain information edit screen 2700, whether the host 100 is allowed to register with the DD. If the restriction 1801 is “Allow,” the program registers the host 100 with the DD. Otherwise, the program registers the host with a DD whose restriction is “Free.” If the restriction 1801 is “Ask,” the program can automatically register the host 100 with a specified DD on the basis of network identification 1901 of the ACL information table 1701 and restriction information 1903 which has been entered through the ACL information edit screen 2800. Thus, registration of hosts with individual DDs can be restricted, registration to a DD that is not intended by an administrator can be prevented, and consequently the level of security is improved. Furthermore, settings for each individual host 100 can be automatically made and a host can be registered with a DD intended by an administrator, with reduced costs of maintenance by the administrator.

### Third embodiment

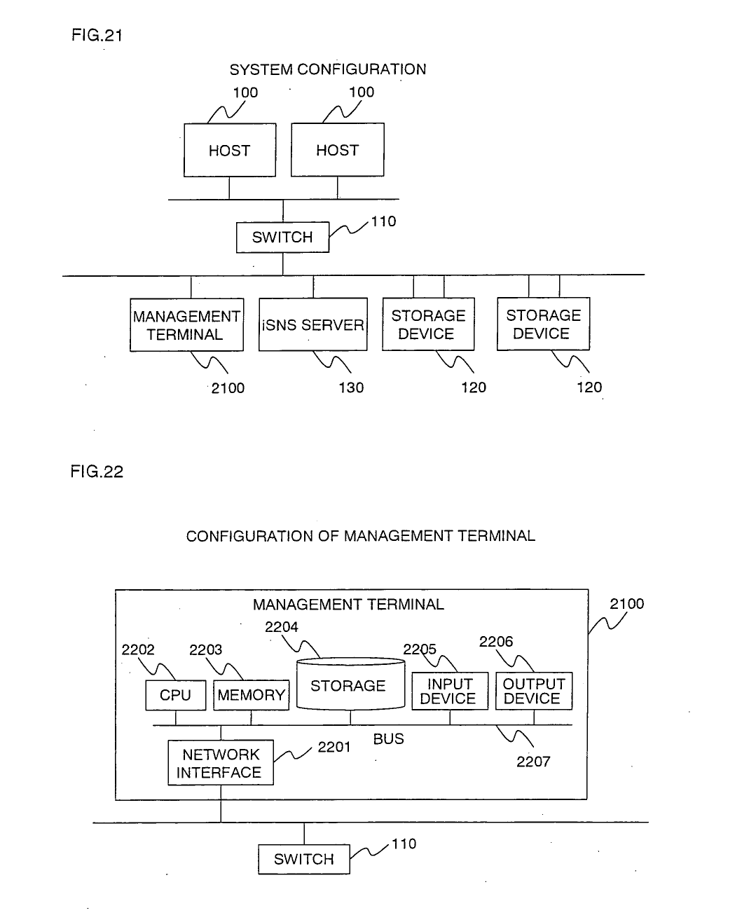

A third embodiment will be described below. A system configuration in the third embodiment is shown in FIG. 21. Hosts 100, storage devices 120, and an iSNS server 130 are the same as those in the first embodiments and therefore detailed description of which will be omitted. The following description will focus on differences from the first embodiment. A management terminal 2100 is a terminal for managing data on the iSNS server 130 and is capable of making settings for allowing or preventing registration of initiators.

FIG. 22 shows a configuration of the management terminal. The management terminal 2100, which is a terminal for managing data on the iSNS server 130, includes a network interface 2101 for sending and receiving data to and from a network, a CPU 2102 executing programs to control the entire terminal, a memory 2103, which is a memory area for programs, a storage 2104 for storing programs and user data and the like, an input device 2105 such as a keyboard and mouse for inputting information by a user, an output device 2106 such as a display for presenting outputs to the user, and a bus 2107 for transferring these data.

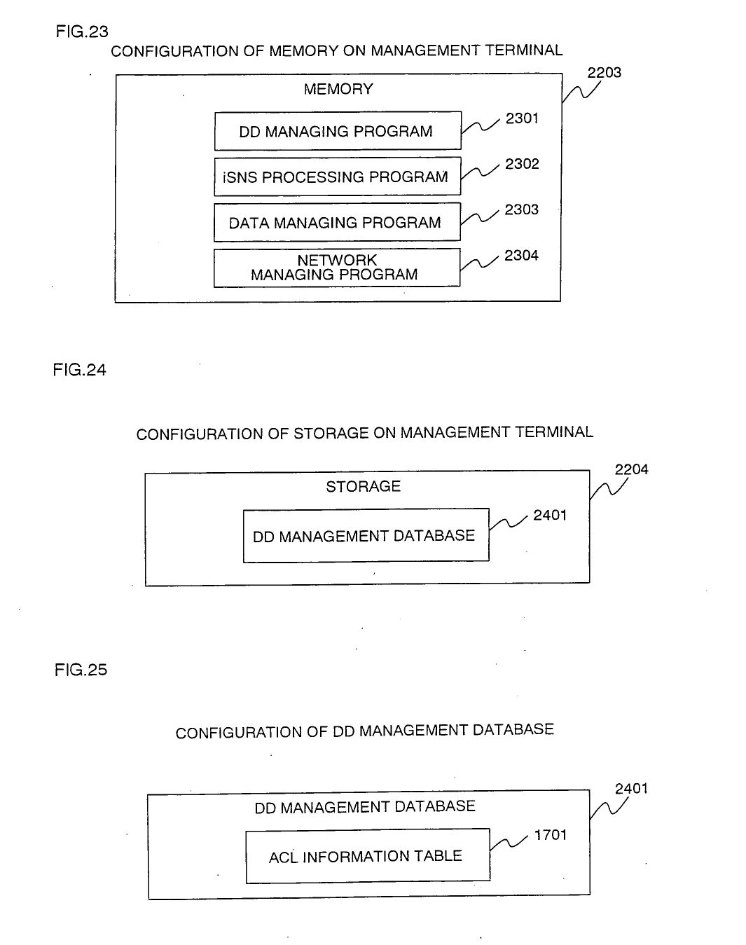

FIG. 23 shows a configuration of the memory. The memory 2203 contains a network processing program 2304 for sending and receiving data to and from the network interface 101, a data managing program 2303 for managing data through screen operations, an iSNS processing program 2302 responsible for processing iSNS messages, and a DD managing program 2301, which is a feature of the present invention.

FIG. 24 shows a configuration of a storage of the management terminal. The storage 2204 contains a DD management database 2401 in which the DD managing program 601 reads/write data.

FIG. 25 shows a configuration of the DD management database. The DD management database 2401 includes an ACL information table 1701 containing information DD registration approval. The structure of the ACL information table is the same as that in the second embodiment.

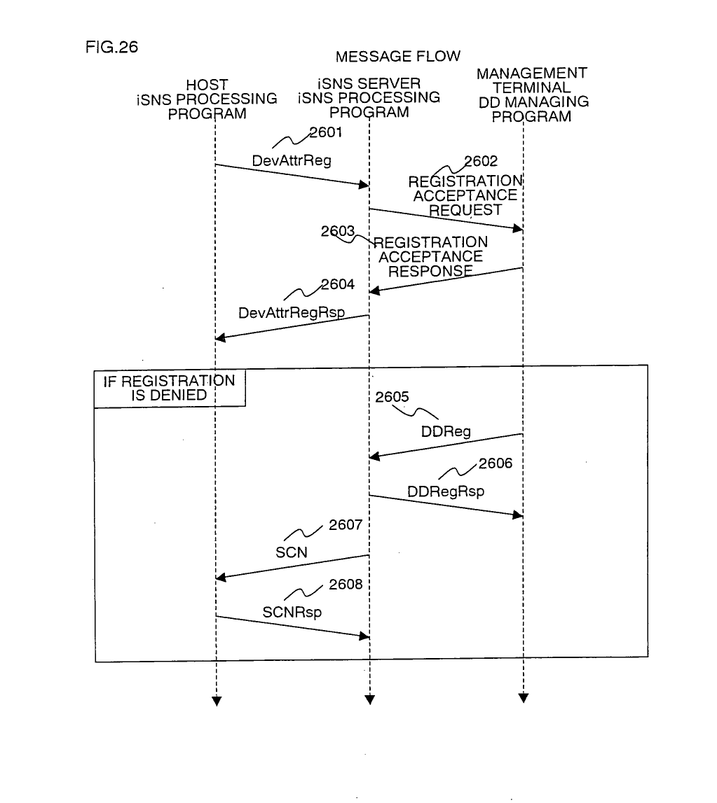

FIG. 26 shows an exemplary message flow. An iSNS processing program 201 on a host 100 sends a DevAttrReg message 2601 to the iSNS processing program 602 on the iSNS server 130. When receiving the message, the iSNS processing program 602 on the iSNS server 130 sends a registration acceptance request message 2602 to the DD management program 2301 of the management terminal 2100. The DD managing program 2301 on the management terminal 2100 receives the message and determines whether the host is allowed to register with a DD and sends a registration acceptance response message 2603 to the iSNS processing program 602 on the iSNS server 130. The iSNS processing program 602 of the iSNS server 130 receives the message and sends a DevAttrRegRsp message 2604 to the iSNS processing program 201 of the host 100. If the response to the registration acceptance request message 2602 is denial, the DD managing program 601 of the iSNS server 130 sends a DDReg message 2605 to the iSNS processing program 602 of the iSNS server 130 in order to register the host to another DD. The iSNS processing program 602 of the iSNS server 130 receives the message, registers the host 100 with a specified DD, and sends a DDRegRsp message 2606 to the DD managing program 2301 on the management terminal 2100. When the DD is changed, the iSNS processing program 602 of the iSNS server 130 sends an SCN message 2607 to the ISNS processing program 201 on the host 100. The iSNS processing program 201 receives the message and sends an SCNRsp message 2608 to the iSNS processing program 602 on the ISNS server 130.

The operation flows of these programs are the same as those in the second embodiment. The discovery domain information edit screen and ACL information edit screen are also the same as those shown in the first embodiment. The flowchart of the data management program operates as shown in the flowchart in the first embodiment. Therefore detailed description of these is omitted.

According to the present embodiment, if a host 100 attempts to register with a DD, the DD managing program 2301 running on the management terminal determines whether the host 100 is allowed to register with the DD, on the basis of a restriction 1801 which has been entered in the discovery domain information table 702 through the discovery domain information edit screen 2700. If the restriction 1801 is “Allow,” the program registers the host 100 with the specified DD. Otherwise, the program registers the host 100 with a DD whose restriction is “Free.” If the restriction 1801 is “Ask,” the program can automatically register the host 100 with a specified DD on the basis of network identification 1901 of the ACL information table 1701 and restriction 1903 information which have been entered through the ACL information edit screen 2800. Thus, registration of hosts with individual DDs can be restricted and registration to a DD that is not intended by an administrator can be prevented and consequently the level of security can be improved. Furthermore, settings for each individual host 100 can be automatically made and a host can be registered with a DD intended by an administrator, with reduced costs of maintenance by the administrator. Because the ACL information table 1701 can be managed on the management terminal 2100 instead of the iSNS server 130, various requests, such as those for updating the ACL information table 1701 which are frequently made can be readily accommodated.

As has been described, the present invention provides a storage network system including hosts, an ISNS server, and storage devices interconnected through a network and being capable of controlling access from an initiator to any of the storage devices. The storage network system includes registration restriction setting means for making a setting for each of the targets for allowing or preventing registration of an initiator.

The present invention also provides a storage network system, wherein the iSNS server has the registration restriction setting means.

The present invention also provides a storage network system including a management terminal connected to the network, wherein the management terminal has the registration restriction setting means.

The present invention also provide a storage network system including registration free setting means for making a setting for the target for allowing an initiator to be registered with the target without restriction.

The present invention also provides a storage network system including query setting means for making a setting for the target for inquiring about restriction on registration of an initiator and registration restriction information storage means for storing information about registration restriction to be returned in response to the query about the restriction on registration of the initiator.

The present invention also provides an access control method for controlling access from an initiator to a target storage device in a storage network system including hosts, an iSNS server, and storage devices interconnected through a network, comprising the step of making a setting for allowing or preventing registration of an initiator.

What is claimed is:

1. A storage network system including hosts, an ISNS server, and storage devices interconnected through a network and being capable of controlling access from an initiator to any of said storage devices that is a target, comprising,
registration restriction setting means for making a setting for each of said target for allowing or preventing registration of an initiator.

2. The storage network system according to claim 1, wherein said iSNS server has said registration restriction setting means.

3. The storage network system according to claim 1, further comprising a management terminal connected to said network, wherein said management terminal has said registration restriction setting means.

4. The storage network system according to any one of the preceding claims, further comprising registration free setting means for making a setting for said target for placing no restriction on registration of an initiator.

5. The storage network system according to any one of the preceding claims, further comprising query setting means for making a setting for said target for inquiring about restriction on registration of an initiator, and registration restriction information storage means for storing information about registration restriction to be returned in response to the query about the restriction on registration of the initiator.

6. A storage network system including hosts, an iSNS server, a management terminal, and storage devices interconnected through a network and being capable of controlling an access from an initiator to any of said storage devices that is a target, wherein said management terminal has registration restriction setting means for making a setting for each of said targets for allowing or preventing registration of an initiator.

7. An access control method for controlling access from an initiator to a target storage device in a storage network system including hosts, an iSNS server, and storage devices interconnected through a network, comprising the step of making a setting for allowing or preventing registration of an initiator.
